(19) United States
(12) Patent Application Publication
(10) Pub. No.: US 2022/0330651 A1
(43) Pub. Date: Oct. 20, 2022

(54) SHOCK ABSORPTION AND VENTILATION ENHANCED SHOE SOLE AND PREPARATION METHOD THEREFOR

(71) Applicant: Zhaoming Wei, Dongguan (CN)

(72) Inventor: Zhaoming Wei, Dongguan (CN)

(21) Appl. No.: 17/760,758

(22) PCT Filed: Feb. 27, 2020
(86) PCT No.: PCT/CN2020/076980

§ 371 Date: Mar. 15, 2022

(51) Int. Cl. A43B 7/08; A43B 7/32; A43B 13/04; A43B 13/02; A43B 13/16

(52) U.S. Cl. CPC A43B 7/088; A43B 7/32; A43B 13/04; A43B 13/023; A43B 13/16

(57) ABSTRACT

Disclosed are a shock absorption and ventilation enhanced shoe sole and a preparation method therefor. The shoe sole comprises a body. At least one layer of communication-type air passage is provided in the body, and a plurality of first air holes provided in the circumferential side face of the body and a plurality of second air holes provided in the upper surface of the body cooperate, so that air intake and deflation for heat exhaust can be alternately achieved in the process of alternately lifting a foot and treading of a user, thereby preventing heat from accumulating on the foot sole, being beneficial to foot health, reducing foot perspiration, and helping slow down heart rate acceleration; and in addition, the shoe sole can achieve the functions of shock absorption, buffering, ventilation and power assistance, so that the shoe sole is more comfortable to wear.

### BACKGROUND OF THE INVENTION

### 1. Field of the Invention

The present invention relates to footwears, and more particularly to a shock absorption and ventilation enhanced shoe sole and a preparation method therefor.

### 2. Description of the Prior Art

Shoes are our daily necessities. Human feet, particularly the toes and their peripheries, tend to sweat and with shoes worn on the feet, the heat and dampness are hard to escape, leaving the interior of shoes warm and wet to become a breeding ground for fungi. Therefore, wearing unbreathable shoes is known to be a main cause of athlete's foot.

Some existing shoe products bragging about breathability merely have some raised features formed at the upper surface of the sole. While these features are aimed at creating air channels, they in fact are incompetent to make soles and shoes breathable, not to mention comfort and shock absorption. Hence, there is a need for an improved sole structure.

### SUMMARY OF THE INVENTION

In view of the need, and in order to address the shortcomings of the prior art about inferior breathability and shock absorption, the primary objective of the present invention is to provide a shock absorption and ventilation enhanced shoe sole and a preparation method therefor.

To achieve the aforementioned objective, the present invention adopts the following technical schemes.

The present invention provides a shock absorption and ventilation enhanced shoe sole, comprising: a body, which is made of a soft material and defines therein at least one layer of interconnecting air passages, in which the body has a peripheral surface formed with a plurality of first air holes that are communicated with edges of the interconnecting air passages, a lower surface formed as a closed surface, and an upper surface formed with a plurality of second air holes that extend downward and are communicated with the interconnecting air passages.

Preferably, the interconnecting air passages come in multiple layers. The multi-layer interconnecting air passages are vertically spaced. The plural first air holes come in multiple layers vertically arranged. The first air holes in each layer are communicated with the corresponding interconnecting air passages.

Preferably, the body is made by stacking and integrating multiple base pieces vertically into a unity. Every adjacent two of the base pieces are of the same or different colors. The interconnecting air passages are located between every adjacent two of the base pieces.

Preferably, the multiple base pieces are such arranged that they are declined in thickness from bottom to top, or have the same thickness.

Preferably, the body is made of EVA.

A method for producing the foregoing shock absorption and ventilation enhanced shoe sole, comprising steps of

(1) providing at least two base pieces to be stacked vertically;

(2) at a position corresponding to where the at least two base pieces are stacked, applying an oily, volatile material to any of stacking surfaces, so as to form a coated area that is interconnected;

(3) stacking the at least two base pieces vertically, heating the stacked base pieces to volatilize the oily, volatile material from the coated area, so that the stacking surfaces, except for positions corresponding to the coated area, are bonded into the united body, thereby forming one said layer of the interconnecting air passages between the base pieces corresponding to the coated area, forming the first air holes on the peripheral surface of the body, the first air holes being communicated with the edges of the interconnecting air passages; and

(4) boring holes in the body, wherein the holes do not pass through the lower surface of the body so that the lower surface of the body is formed as the closed surface, forming the second air holes on the upper surface of the body, the second air holes extending downward and being communicated with the interconnecting air passages.

A method for producing the foregoing shock absorption and ventilation enhanced shoe sole, comprising steps of

(1) providing at least two base pieces to be stacked vertically;

(2) at a position corresponding to where the at least two base pieces are stacked, applying an oily, volatile material to any of stacking surfaces, so as to form a coated area that is interconnected;

(3) stacking the at least two base pieces vertically, heating the stacked base pieces to volatilize the oily, volatile material from the coated area, so that the stacking surfaces, except for positions corresponding to the coated area, are bonded into the united body, thereby forming one said layer of the interconnecting air passages between the base pieces corresponding to the coated area, forming the first air holes on the peripheral surface of the body, the first air holes being communicated with the edges of the interconnecting air passages;

(4) punching the body to form the second air holes on the upper surface of the body, the second air holes extending downward and being communicated with the interconnecting air passages, the second air holes passing through the lower surface of the body; and

(5) forming a bottom layer at the bottommost base piece, so that the bottom layer seals lower openings of the second air holes to form the lower surface of the body into the closed surface.

Compared with the prior art, the present invention has obvious advantages and beneficial effects. Specifically, it can be known from the above technical scheme:

The design of the present invention features the least one layer of interconnecting air passages in the body as well as the first and second air holes at the peripheral surface and the upper surface of the body. Thereby, as a user wearing shoes equipped with the shoe soles alternately lifts and lands his/her feet, the shoe soles suck fresh air in and exhaust air with heat alternately, so as to prevent heat from accumulating around thenars of the user. Use of the shoe sole helps reduce foot sweat, improve foot health, and mitigate increase of the heart rate. Moreover, the shoe sole provides shock-absorbing, buffering, ventilating, and boosting functions, making shoe-wearing more comfortable.

Embodiments of the present invention will now be described, by way of example only, with reference to the accompanying drawings.

### BRIEF DESCRIPTION OF THE DRAWINGS

FIG. 1 is a perspective view of a shoe sole according to one preferred embodiment of the present invention, with the shoe sole sectioned to show its cross section;

FIG. 2 shows the shoe sole of FIG. 1 in a different point of view; and

FIG. 3 is a partial, exploded view of the shoe sole according to the preferred embodiment of the present invention.

### DETAILED DESCRIPTION OF THE PREFERRED EMBODIMENTS

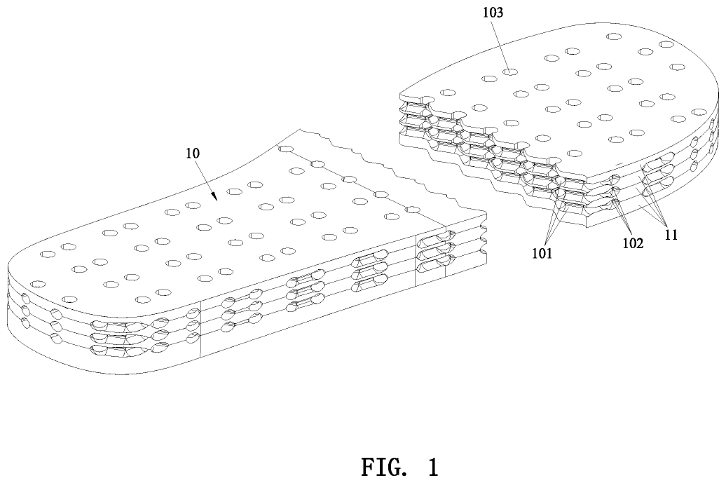

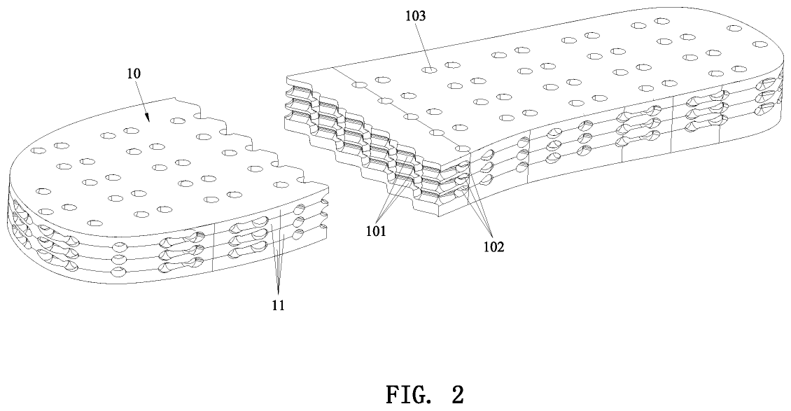

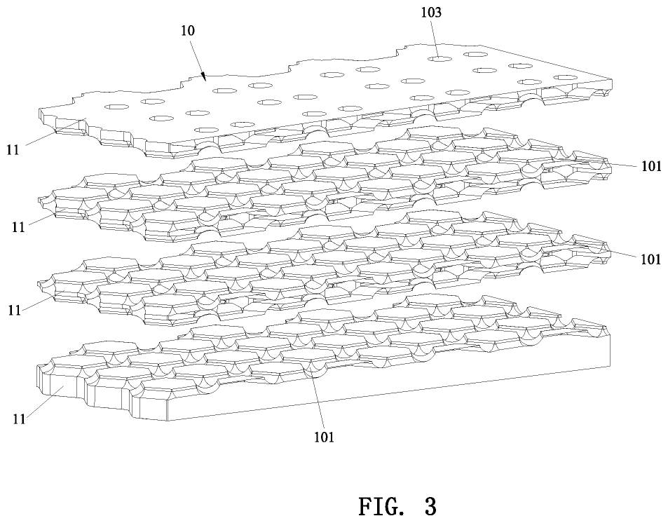

Referring to FIG. 1 through FIG. 3, in a preferred embodiment of the present invention, a shock absorption and ventilation enhanced shoe sole comprises a body 10.

The body 10 is made of a soft material. The body 10 defines therein at least one layer of interconnecting air passages 101. The body 10 has its peripheral surface formed with a plurality of first air holes 102. The plural first air holes 102 are communicated with edges of the interconnecting air passages 101. The body 10 has its lower surface formed as a closed surface. The body 10 has its upper surface formed with a plurality of second air holes 103. The plural second air holes 103 all extend downward and are communicated with the interconnecting air passages 101. The plural second air holes 103 are distributed across the upper surface of the body 10. Every second air hole 103 is round, and the interconnecting air passages 101 are preferably formed into a net-like structure.

In the present embodiment, the body 10 is made of EVA. The interconnecting air passages 101 come in multiple layers. The multi-layer interconnecting air passages 101 are vertically spaced in a positionally corresponding arrangement. The plural first air holes 102 come in multiple layers vertically arranged. The first air holes 102 in each layer are communicated with the corresponding interconnecting air passages 101.

Furthermore, the body 10 is made by stacking and integrating multiple base pieces 11 vertically into a unity. The adjacent two base pieces 11 may be of the same or different colors. The interconnecting air passages 101 are located between two adjacent base pieces 11. The multiple base pieces 11 may be such arranged that they are declined in thickness from bottom to top, or may have the same thickness, but no limited thereto. In the present embodiment, there are four base pieces 11 stacked together. The bottommost base piece 11 has the greatest thickness, and the topmost base piece 11 has the smallest thickness. The interconnecting air passages 101 and the first air hole 102 both come in three layers, so as to provide desired breathability and shock absorption.

The present invention further provides a method for producing the shock absorption and ventilation enhanced shoe sole, which comprises the following steps:

(1) providing at least two base pieces 11 to be stacked vertically;

(2) at a position corresponding to where the at least two base pieces are stacked, applying an oily, volatile material to any of stacking surfaces, so as to form a coated area that is interconnected;

(3) stacking the at least two base pieces 11 vertically, heating the stacked base pieces 11 to volatilize the oily, volatile material from the coated area, so that the stacking surfaces, except for positions corresponding to the coated area, are bonded into the united body 10, thereby forming one said layer of the interconnecting air passages 101 between the base pieces 11 corresponding to the coated area, forming the first air holes 102 on the peripheral surface of the body 10, the first air holes 102 being communicated with the edges of the interconnecting air passages 101; and

(4) boring holes in the body 10, wherein the holes do not pass through the lower surface of the body 10 so that the lower surface of the body is formed as the closed surface, forming the second air holes 103 on the upper surface of the body 10, the second air holes 103 extending downward and being communicated with the interconnecting air passages 101.

The present invention further provides a method for producing the shock absorption and ventilation enhanced shoe sole, which comprises the following steps:

(1) providing at least two base pieces 11 to be stacked vertically;

(2) at a position corresponding to where the at least two base pieces are stacked, applying an oily, volatile material to any of stacking surfaces, so as to form a coated area that is interconnected;

(3) stacking the at least two base pieces 11 vertically, heating the stacked base pieces 11 to volatilize the oily, volatile material from the coated area, so that the stacking surfaces, except for positions corresponding to the coated area, are bonded into the united body 10, thereby forming one said layer of the interconnecting air passages 101 between the base pieces 11 corresponding to the coated area, forming the first air holes 102 on the peripheral surface of the body 10, the first air holes being communicated with the edges of the interconnecting air passages 101;

(4) punching the body 10 to form the second air holes 103 on the upper surface of the body 10, the second air holes 103 extending downward and being communicated with the interconnecting air passages 101, the second air holes 103 passing through the lower surface of the body 10; and

(5) forming a bottom layer at the bottommost base piece 11, so that the bottom layer seals lower openings of the second air holes 103 to form the lower surface of the body 10 into the closed surface as described above.

The shoe sole is used to make a shoe. When worn by a user who is taking exercise, the shoe sole works like an air bag. To be specific, when the user lands his/her feet on the ground and presses the shoe sole, the body 10 deforms to make air in the interconnecting air passages 101 escape from the first air holes 102 and the second air holes 103, so as to dissipate heat and dampness. When the user lifts his/her feet, the body 10 restores its shape by sucking external fresh air into the interconnecting air passages 101 through the first air holes 102 and the second air holes 103. Thereby, as the user alternately lifts and lands his/her feet, the shoe soles suck fresh air in and exhaust air with heat alternately, so as to prevent heat from accumulating around thenars of the user. Use of the shoe sole helps reduce foot sweat, improve foot health, and mitigate increase of the heart rate. Moreover, the shoe sole provides shock-absorbing, buffering, ventilating, and boosting functions, making shoe-wearing more comfortable.

To sum up, the design of the present invention features the least one layer of interconnecting air passages in the body as well as the first and second air holes at the peripheral surface and the upper surface of the body. Thereby, as a user wearing shoes equipped with the shoe soles alternately lifts and lands his/her feet, the shoe soles suck fresh air in and exhaust air with heat alternately, so as to prevent heat from accumulating around thenars of the user. Use of the shoe sole helps reduce foot sweat, improve foot health, and mitigate increase of the heart rate. Moreover, the shoe sole provides shock-absorbing, buffering, ventilating, and boosting functions, making shoe-wearing more comfortable.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A shock absorption and ventilation enhanced shoe sole, comprising: a body, which is made of a soft material and defines therein at least one layer of interconnecting air passages, in which the body has a peripheral surface formed with a plurality of first air holes that are communicated with edges of the interconnecting air passages, a lower surface formed as a closed surface, and an upper surface formed with a plurality of second air holes that extend downward and are communicated with the interconnecting air passages.

2. The shock absorption and ventilation enhanced shoe sole of claim 1, wherein the interconnecting air passages come in multiple layers, the multi-layer interconnecting air passages are vertically spaced, the plural first air holes come in multiple layers vertically arranged, and the first air holes in each layer are communicated with the corresponding interconnecting air passages.

3. The shock absorption and ventilation enhanced shoe sole of claim 1, wherein the body is made by stacking and integrating multiple base pieces vertically into a unity, every adjacent two of the base pieces are of the same or different colors, and the interconnecting air passages are located between every adjacent two of the base pieces.

4. The shock absorption and ventilation enhanced shoe sole of claim 1, wherein the multiple base pieces are such arranged that they are declined in thickness from bottom to top, or have the same thickness.

5. The shock absorption and ventilation enhanced shoe sole of claim 1, wherein the body is made of EVA.

6. A method for producing the shock absorption and ventilation enhanced shoe sole of claim 1, comprising steps of
(1) providing at least two base pieces to be stacked vertically;
(2) at a position corresponding to where the at least two base pieces are stacked, applying an oily, volatile material to any of stacking surfaces, so as to form a coated area that is interconnected;
(3) stacking the at least two base pieces vertically, heating the stacked base pieces to volatilize the oily, volatile material from the coated area, so that the stacking surfaces, except for positions corresponding to the coated area, are bonded into the united body, thereby forming one said layer of the interconnecting air passages between the base pieces corresponding to the coated area, forming the first air holes on the peripheral surface of the body, the first air holes being communicated with the edges of the interconnecting air passages; and
(4) boring holes in the body, wherein the holes do not pass through the lower surface of the body so that the lower surface of the body is formed as the closed surface, forming the second air holes on the upper surface of the body, the second air holes extending downward and being communicated with the interconnecting air passages.

7. A method for producing the shock absorption and ventilation enhanced shoe sole of claim 1, comprising steps of
(1) providing at least two base pieces to be stacked vertically;
(2) at a position corresponding to where the at least two base pieces are stacked, applying an oily, volatile material to any of stacking surfaces, so as to form a coated area that is interconnected;
(3) stacking the at least two base pieces vertically, heating the stacked base pieces to volatilize the oily, volatile material from the coated area, so that the stacking surfaces, except for positions corresponding to the coated area, are bonded into the united body, thereby forming one said layer of the interconnecting air passages between the base pieces corresponding to the coated area, forming the first air holes on the peripheral surface of the body, the first air holes being communicated with the edges of the interconnecting air passages;
(4) punching the body to form the second air holes on the upper surface of the body, the second air holes extending downward and being communicated with the interconnecting air passages, the second air holes passing through the lower surface of the body; and
(5) forming a bottom layer at the bottommost base piece, so that the bottom layer seals lower openings of the second air holes to form the lower surface of the body into the closed surface.
